(19) United States
(12) Patent Application Publication
(10) Pub. No.: US 2022/0414659 A1
(43) Pub. Date: Dec. 29, 2022

(54) AUTHORIZATION DEVICE

(71) Applicant: NTT DOCOMO, INC., Chiyoda-ku (JP)

(72) Inventors: Hiroyuki HAKODA, Chiyoda-ku (JP); Yoshiki SAWAKAMI, Chiyoda-ku (JP)

(73) Assignee: NTT DOCOMO, INC., Chiyoda-ku (JP)

(21) Appl. No.: 17/775,750

(22) PCT Filed: Oct. 7, 2020
(86) PCT No.: PCT/JP2020/038009

§ 371 Date: May 10, 2022

(30) Foreign Application Priority Data
Nov. 22, 2019 (JP) 2019-211115

(51) Int. Cl. G06Q 20/40; G06Q 20/32

(52) U.S. Cl. CPC G06Q 20/4015; G06Q 20/3224; G06Q 20/4016

(57) ABSTRACT

An object of the present invention is to provide an authorization device that enables payment approval processing according to a country where a communication terminal is located. An authorization server 100 includes a customer information database that stores a card number of a credit card being a payment means and a communication terminal 300 being a user terminal in association with each other. A location based authorization determination unit 102 determines legitimacy of a payment with a credit card on the basis of whether location country information based on location registration of the communication terminal 300 when the payment with the credit card is made and country information (payment country information in an authorization request) based on a location of an affiliated store (store) where the payment with the credit card is made satisfy a predetermined condition or not. A authorization control unit 101 transmits a determination result about legitimacy of the payment to an affiliated store 200.

### TECHNICAL FIELD

The present invention relates to an authorization device for approving a user payment.

### BACKGROUND ART

According to the invention described in Patent Literature 1, when a user makes a credit card payment, the credit card for use and a mobile terminal are associated in advance, and an authentication server authenticates that the location of the registered mobile terminal matches the place of use.

### CITATION LIST

### Patent Literature

PTL1: Japanese Unexamined Patent Publication No. 2005-216210

### SUMMARY OF INVENTION

### Technical Problem

Fraud payments are mostly payments from overseas. Thus, payments from overseas are subject to suspicion of fraud, and identity verification by telephone or the like is required in many cases. As described in the above Patent Literature 1, to use location information, a mobile terminal needs to have a positioning function.

To solve the above problem, an object of the present invention is to provide an authorization device that determines the legitimacy of a payment without identity verification by telephone or the like with a simple configuration of a terminal.

### Solution to Problem

An authorization device according to the present invention includes a customer information storage unit configured to store a payment means and a user terminal in association with each other, a determination unit configured to determine legitimacy of a payment with the payment means on the basis of whether location country information based on location registration of the user terminal when the payment with the payment means is made and country information based on a location of a store where the payment with the payment means is made satisfies a predetermined condition or not, and an output unit configured to output a determination result about legitimacy of the payment.

According to the present invention, it is capable of determining the legitimacy of a payment on the basis of a country where a user terminal is located and a country where a payment with a payment means is made.

### Advantageous Effects of Invention

According to the present invention, it is capable of determining the legitimacy of a payment by using a country where a user is located.

### BRIEF DESCRIPTION OF DRAWINGS

FIG. 1 is a block diagram showing a system configuration of an authorization server 100 according to an embodiment;

FIG. 2 is a flowchart showing an operation of the authorization server 100 (location based authorization determination unit 102);

FIG. 3 is a block diagram showing a system configuration of an authorization server 100a according to a second embodiment;

FIG. 4 is a flowchart showing an operation of the authorization server 100a (location based authorization determination unit 102);

FIG. 5 is a block diagram showing a system configuration of an authorization server 100b according to an alternative example;

FIG. 6 is a flowchart showing an operation of the authorization server 100b;

FIG. 7 is a block diagram showing a system configuration of an authorization server 100c according to a third embodiment;

FIG. 8 is a flowchart showing an operation of the authorization server 100c;

FIG. 9 is a block diagram showing a system configuration of an authorization server 100d according to a fourth embodiment; and

FIG. 10 is a view showing an example of a hardware configuration of an authorization server 100 and the like according to one embodiment of the present disclosure.

### DESCRIPTION OF EMBODIMENTS

Embodiments of the present invention are described hereinafter with reference to the attached drawings. Note that, where possible, the same elements are denoted by the same reference symbols and redundant description thereof is omitted.

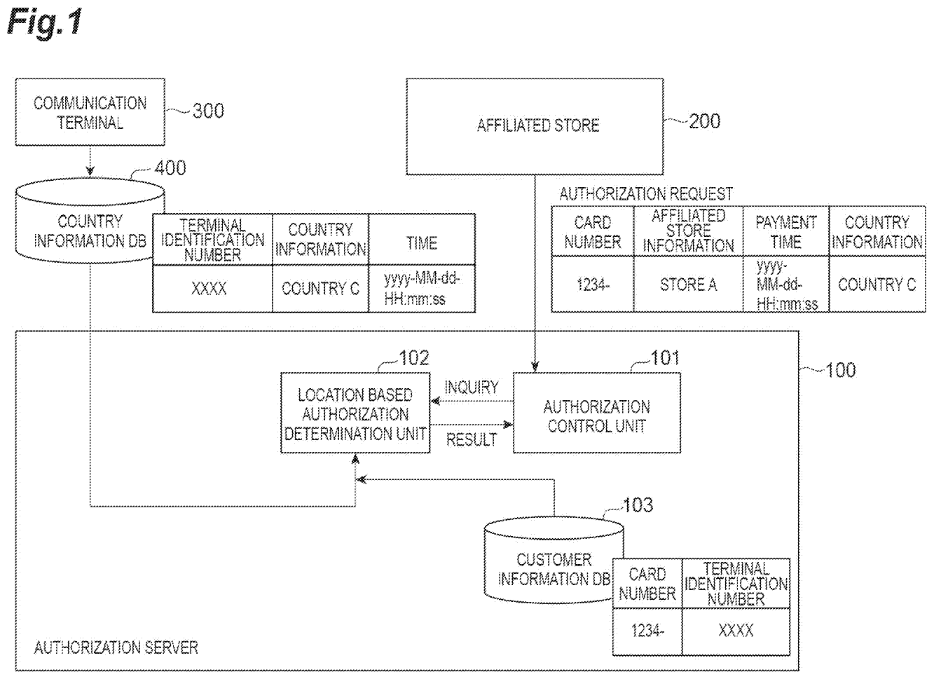

FIG. 1 is a view showing a system configuration of an authorization server 100 according to this embodiment (which is referred to hereinafter as the authorization server 100). As shown therein, the authorization server 100 determines the legitimacy of a payment means such as a credit card by determining a match or mismatch of countries of location on the basis of country information in an authorization request received from an affiliated store 200 and country information in a country information DB 400 (country information storage unit).

This embodiment is based on the premise that a user have a credit card and a communication terminal 300 together, and in this case, since country information generally match, it is determined that a payment with the credit card by this user is legitimate. Each element is described hereinafter.

Further, the country information DB 400 is a database that stores country information of a country for which the communication terminal 300 has made location registration with a mobile communication network and a time when it is located in this country, and it is information based on location registration that is typically used in a mobile phone or the like.

The authorization server 100 includes an authorization control unit 101 (output unit), a location based authorization determination unit 102, and a customer information DB 103 (customer information storage unit).

The authorization control unit 101 is a part that receives an authorization request from the affiliated store 200 and then makes an inquiry to the location based authorization determination unit 102, and transmits a result to the affiliated store 200. Note that the affiliated store 200 in this example includes a credit card payment terminal, and this payment terminal transmits an authorization request to the authorization server 100 when making a payment transaction at the time of a credit card payment. This authorization request contains a card number of a credit card, affiliated store information, payment time, and country information. The affiliated store information is information (identification number etc.) for identifying an affiliated store. The country information is information indicating a country where an affiliated store is located.

The location based authorization determination unit 102 is a part that receives an inquiry from the authorization control unit 101 and then determines the legitimacy of a payment with a credit card indicated by the card information. Specifically, the location based authorization determination unit 102 refers to the customer information DB 103 by using the card number contained in the authorization request as a key, and thereby acquires a terminal identification number. The location based authorization determination unit 102 then refers to the country information DB 400 and acquires country information corresponding to the terminal identification number. Then, the location based authorization determination unit 102 compares country information (payment country information) contained in the authorization request and country information (location country information) acquired from the country information DB 400, and determines a match or mismatch. When the location based authorization determination unit 102 determines that those country information match, it determines that a payment with the credit card with the card number contained in the authorization request is legitimate. When, on the other hand, the location based authorization determination unit 102 determines that those country information mismatch, it determines that this payment is fraud. The location based authorization determination unit 102 transmits a determination result to the authorization control unit 101.

The customer information DB 103 is a database that stores a card number of a credit card and a terminal identification number. It is a database for identifying a terminal identification number of the communication terminal 300 owned by a customer who is a credit card holder.

Note that the location based authorization determination unit 102 may transmit only a determination result of a match or mismatch to the authorization control unit 101, and the authorization control unit 101 may determine legitimacy or fraud of a payment on the basis of this match or mismatch. Further, an authorization comprehensive determination unit placed separately, which is described later, may make a comprehensive determination.

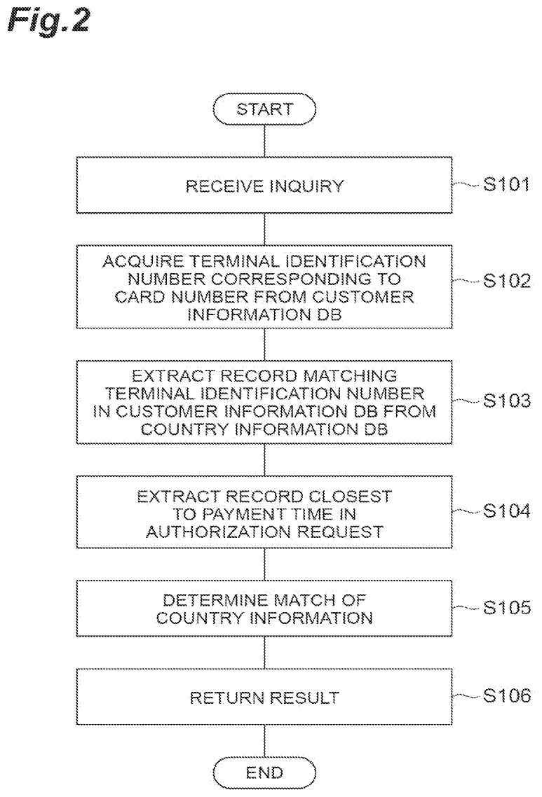

An operation of the authorization server 100 (location based authorization determination unit 102) is described hereinafter. FIG. 2 is a flowchart showing the operation thereof.

When the authorization control unit 101 receives an authorization request from the affiliated store 200, it makes an inquiry to the location based authorization determination unit 102.

When the location based authorization determination unit 102 receives an inquiry about a card number and country information, it acquires a terminal identification number corresponding to the card number from the customer information DB 103 (S102).

Next, the location based authorization determination unit 102 acquires, from the country information DB 400, location records (country information) that match the terminal identification number acquired from the customer information DB 103 (S103).

The location based authorization determination unit 102 acquires a location record (country information) that is closest to the payment time in the authorization request (S104). The location based authorization determination unit 102 then determines the legitimacy of the credit card payment on the basis of a match or mismatch between the country information in the location record and the country information in the authorization request (S105), and transmits a determination result to the authorization control unit 101 (S106). When those country information match, the location based authorization determination unit 102 determines that this payment is legitimate and transmits this result. When, on the other hand, those country information do not match, the location based authorization determination unit 102 determines that this payment is not legitimate and transmits this result.

The authorization control unit 101 transmits a legitimacy determination result to the affiliated store 200.

In this manner, the authorization server 100 is able to determine the legitimacy of a payment with a credit card or the like on the basis of country information. Note that, although a determination is made about the legitimacy of a payment with an electronic payment means such as a credit card in the first embodiment and second, third and fourth embodiments described later, the present invention is not limited thereto. The authorization server 100 is applicable also to an electronic payment means using FeliCa (registered trademark) electronic money for prepaid charging or an electronic payment means using a QR code.

A second embodiment is described hereinafter. Although the country information DB 400 is based on information obtained from base station information in the first embodiment, this information is different from the reality in some cases. Specifically, since the country information DB 400 stores a carrier country code as the country information, wrong country information can be acquired from a country that adopts a telecommunications carrier that provides communications lines to another country. For example, a location management server of a certain country registers a country where it is located as the country information. A location management server of another country does not register a country where it is located as the country information in some cases. In such cases, a carrier country code based on a telecommunications carrier is registered as the country information. In the case of a telecommunications carrier that adopts another country as the carrier country code, the carrier country code can be this another country. Thus, in the second embodiment, it is complemented using a database of country information provided by a carrier.

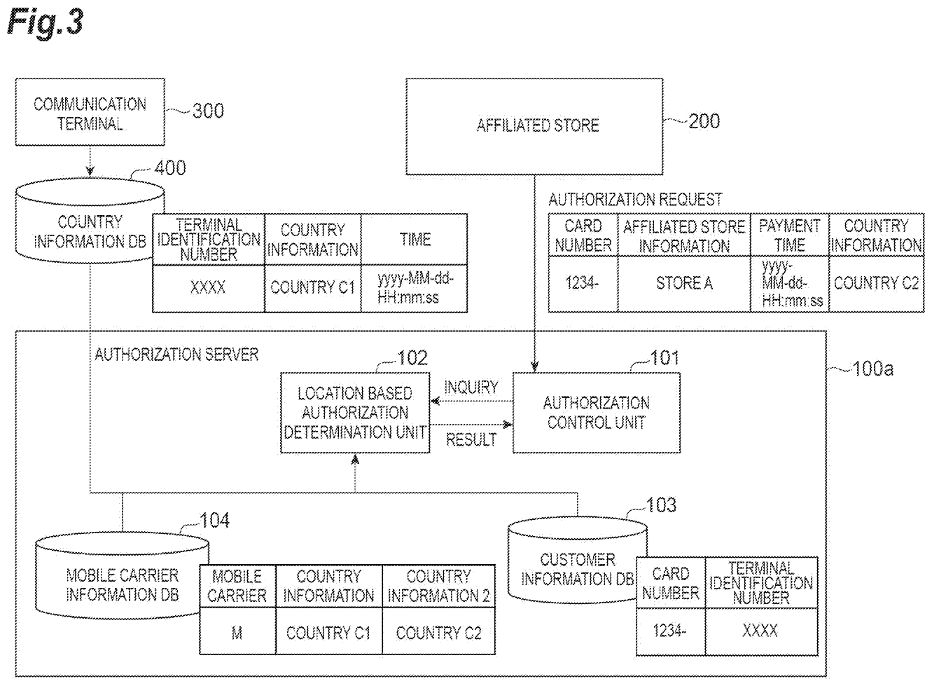

FIG. 3 is a block diagram showing a system configuration of an authorization server 100a according to the second embodiment. The authorization server 100a includes the authorization control unit 101, the location based authorization determination unit 102, the customer information DB 103, and a mobile carrier information DB 104 (mobile carrier information storage unit). This embodiment is different from the first embodiment in that the authorization server 100a includes the mobile carrier information DB 104 and the location based authorization determination unit 102 determines the legitimacy of a payment by using country information acquired by referring to the mobile carrier information DB 104.

The mobile carrier information DB 104 is a database that associates a mobile carrier with country information. This database indicates country information where a mobile carrier provides communications lines. Although country information 1 and country information 2 are associated with a mobile carrier M in FIG. 3, it is not limited thereto, the more country information may be associated.

The location based authorization determination unit 102 acquires a terminal identification number from the customer information DB 103 on the basis of a card number of an authorization request, and acquires country information (location country information) from the country information DB 400. On the basis of the acquired country information (location country information), the location based authorization determination unit 102 acquires one or a plurality of other country information (carrier country information) associated with this country information (location country information) from the mobile carrier information DB 104

The location based authorization determination unit 102 determines the legitimacy of the credit card payment on the basis of whether there is country information that matches the country information (payment country information) in the authorization request among those acquired country information (carrier country information).

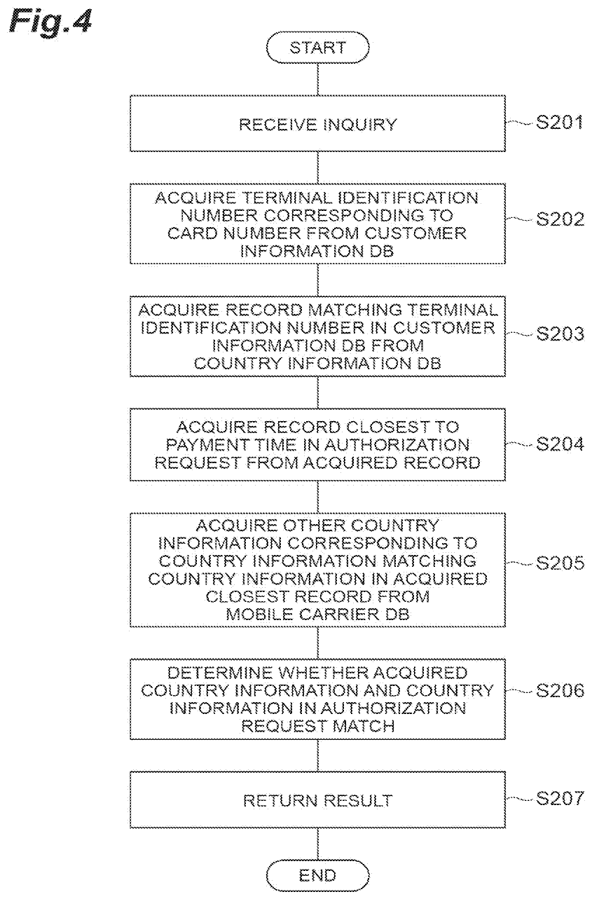

An operation of the authorization server 100a (location based authorization determination unit 102) is described hereinafter. FIG. 4 is a flowchart showing the operation thereof. When the authorization control unit 101 receives an authorization request from the affiliated store 200, it makes an inquiry to the location based authorization determination unit 102. The location based authorization determination unit 102 receives an inquiry (S201), and acquires a terminal identification number corresponding to the card number from the customer information DB 103 (S202).

Next, the location based authorization determination unit 102 acquires, from the country information DB 400, location records (country information) that match the terminal identification number acquired from the customer information DB 103 (S203). It then acquires a location record (country information) that is closest to the payment time contained in the authorization request (S204).

The location based authorization determination unit 102 acquires, from the mobile carrier information DB 104, one or a plurality of other country information (carrier country information; contained in a carrier record) associated with the country information (location country information) contained in the acquired location record (S205).

The location based authorization determination unit 102 determines whether there is a match between the acquired one or plurality of other country information (carrier country information) and the country information (payment country information) contained in the authorization request, and thereby determines the legitimacy of the payment (S206).

The location based authorization determination unit 102 transmits a determination result about the legitimacy of the payment to the authorization control unit 101 (S207). The authorization control unit 101 transmits this determination result to the affiliated store 200. Note that, as described earlier, the location based authorization determination unit 102 may determine only a match or mismatch, and the authorization control unit 101 may determine the legitimacy of a payment on the basis of this match or mismatch.

As described above, a country where the communication terminal 300 is located can be estimated also when the carrier country code of a mobile carrier is treated as the country information. For example, in FIG. 3, the affiliated store 200 is located in a country C2, and the country C2 is contained as the country information in the authorization request. On the other hand, in the country information DB 400, a country C1 is stored as the country where the communication terminal 300 is located. There is a case where this mobile carrier M registers the country C1 as the carrier country code.

In such a case, the payment is determined as fraud in the processing method of the first embodiment because the country information is different between the authorization request and the country information DB 400. However, in this embodiment, by using the mobile carrier information of the communication terminal 300, it is found that this mobile carrier provides communications lines to the country C2. It is thereby determined that the communication terminal 300 is located in the country C2, and this payment may be determined to be legitimate.

A match or mismatch of country information is determined in the above-described second embodiment, it is not limited thereto. For example, in S206 of FIG. 4, the location based authorization determination unit 102 may determine the degree of matching between the acquired one or plurality of other country information (carrier country information) and the country information (payment country information) contained in the authorization request, and calculate the probability that the payment is legitimate.

Specifically, the mobile carrier information DB 104 contains a plurality of country information for a certain carrier in some cases. In such a case, a payment is determined to be legitimate when the country information is contained and determined to be not legitimate when the country information is not contained in the above description. However, when there are two candidate countries (countries stored in the mobile carrier information DB 104) and any one of them has a match, the probability of legitimacy may be set to 50%. The probability may be set to a value obtained by dividing the number of matching countries by the number of candidate countries, such as 30% when there are three candidate countries.

The location based authorization determination unit 102 may calculate this probability and determine a match or mismatch on the basis of this probability, or may transmit this probability to an authorization comprehensive determination unit (described later, for example), which is not shown, and cause it to make a comprehensive determination inconsideration of the probability. Alternatively, the location based authorization determination unit 102 may transmit this probability directly to the affiliated store 200.

This idea regarding the probability is applicable also to the first embodiment, and it is also applicable to an alternative example of the second embodiment, a third embodiment, and a fourth embodiment as a matter of course.

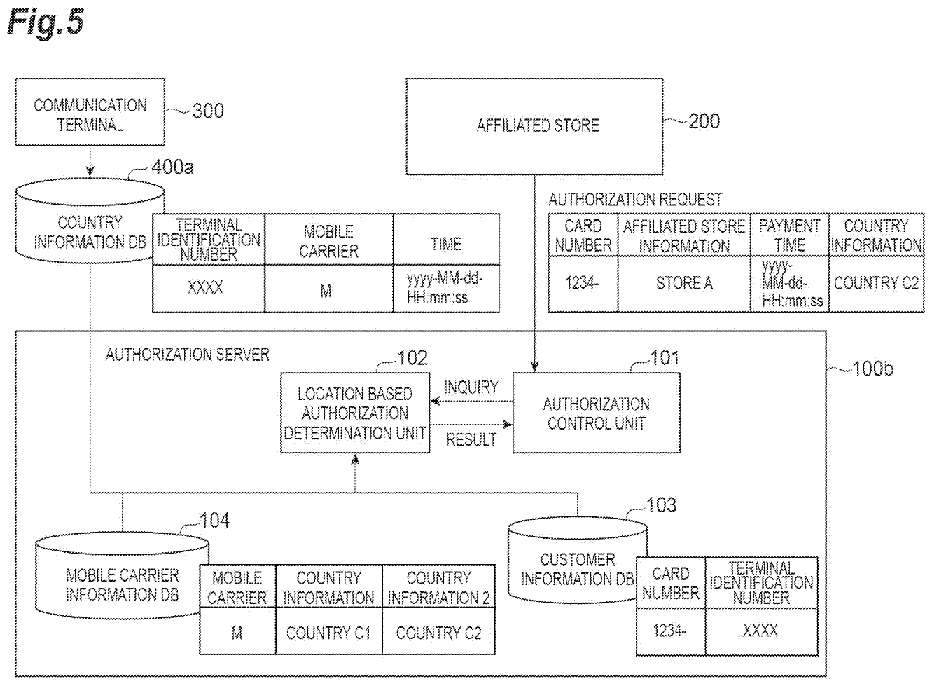

An alternative example of the second embodiment is described hereinafter. FIG. 5 is a block diagram showing a system configuration of an authorization server 100b according to the alternative example. As shown therein, this authorization server 100b includes the authorization control unit 101, the location based authorization determination unit 102, the customer information DB 103, and the carrier information DB 104. It is different from the second embodiment in that it includes a country information DB 400a, and the location based authorization determination unit 102 uses a mobile carrier stored in the country information DB 400a.

The country information DB 400a stores a terminal identification number, a mobile carrier, and time in association with one another, and it is different from the second embodiment in that it stores a mobile carrier. As described above, the country information DB 400a stores information about a mobile carrier that is not converted into country information.

The location based authorization determination unit 102 acquires a mobile carrier used by the communication terminal 300 by using the terminal identification number obtained by referring to the above-described authorization request and the customer information DB 103 as a key. Then, the location based authorization determination unit 102 refers to the mobile carrier information DB 104 by using this mobile carrier as a key, and thereby acquires one or a plurality of country information (carrier country information) covered by the mobile carrier used as the key.

The location based authorization determination unit 102 determines whether there is a match between the acquired one or plurality of country information (carrier country information) and the country information (payment country information) contained in the authorization request. The location based authorization determination unit 102 determines the legitimacy of a payment on the basis of this determination result.

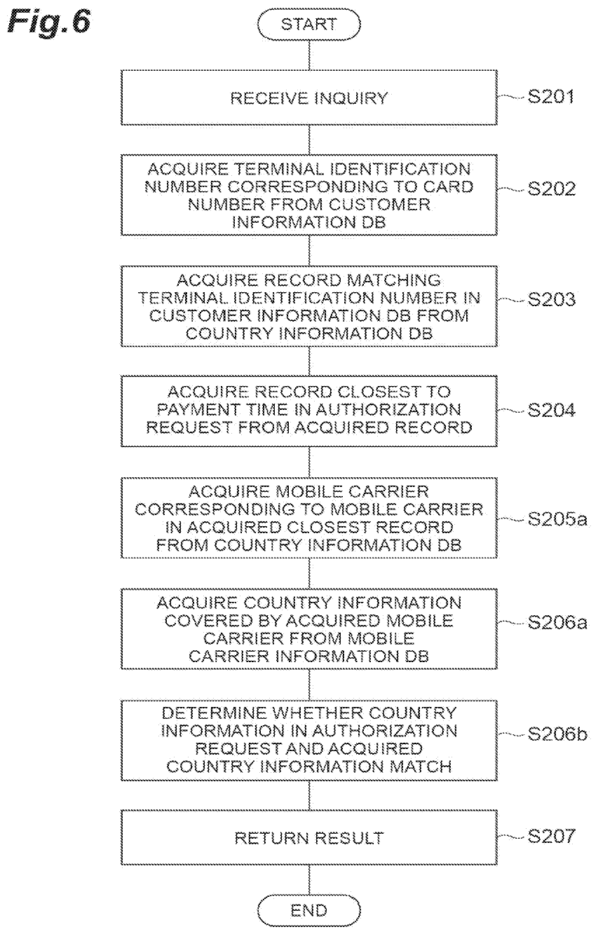

An operation of the authorization server 100b is described hereinafter. FIG. 6 is a flowchart showing the operation thereof. Steps S201 to S204 are the same as those in FIG. 4, and the description thereof is omitted.

The location based authorization determination unit 102 acquires a mobile carrier in a location record that is closest to the payment time from the country information DB 400a (S205a).

The location based authorization determination unit 102 acquires a carrier record that contains one or a plurality of country information covered by the acquired mobile carrier from the mobile carrier information DB 104 (S206a). The location based authorization determination unit 102 determines the legitimacy of a payment on the basis of a match or mismatch between the country information (payment country information) in the authorization request and the country information (carrier country information) in the carrier record (S206b), and transmits this result to the authorization control unit 101 (S207).

In this manner, country information of a country where the communication terminal 300 is located is acquired by using a mobile carrier as a key.

A third embodiment is described hereinbelow. This third embodiment relates to a device that performs a determination process in consideration of an extension of a communication network. Specifically, depending on the location relationship of a mobile carrier or a country, there is a possibility that a line is extended to a bordering country (adjacent country) by an extension of a communication network, and therefore obtained country information is different from the reality in some cases.

Thus, an authorization server 100c according to the third embodiment determines the legitimacy of a payment on the basis of the past information or the location relationship between countries even when there is no match in country information. The past information is, for example, information found to be a legitimate use while country information does not match. The information found to be a legitimate use is when identity verification of a user is directly done by telephone or the like, for example. The location relationship between countries is information indicating that the countries are neighboring countries to each other. In the case of neighboring countries, an extension of a communication network is likely to occur.

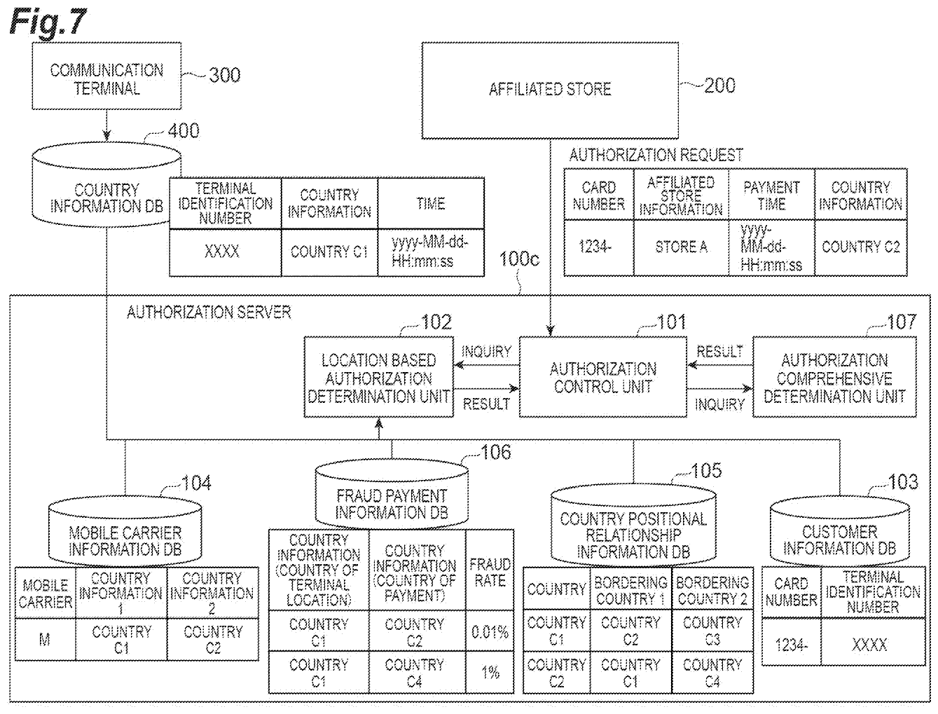

FIG. 7 is a block diagram showing a system configuration of an authorization server 100c according to a third embodiment. This authorization server 100c is different from the second embodiment in that it includes a country location relationship information DB 105 (location relationship information storage unit), a fraud payment information DB 106 (fraud payment information storage unit), and an authorization comprehensive determination unit 107.

The country location relationship information DB 105 is information that associates, with each country, bordering countries (adjacent countries) that are geographically adjacent to the country. In this figure, a country C2 and a country C3 are associated as bordering countries with a country C1.

The fraud payment information DB 106 is information that associates a payment fraud rate between country information (location country information) of a country where a terminal is located and country information (payment country information) of a country where a payment is made. The fraud rate in this fraud payment information DB is previously set by an administrator or the like from information about the past fraud payments (verification by telephone etc.). Note that the fraud rate is not set in some cases such as when the number of samples is small.

The authorization comprehensive determination unit 107 is a part that returns a comprehensive determination result in response to an inquiry from the authorization control unit 101 that has obtained a determination result (fraud rate) from the location based authorization determination unit 102.

The location based authorization determination unit 102 refers to the customer information DB 103 and acquires a terminal identification number on the basis of a card number, payment time, and country information in an authorization request. The location based authorization determination unit 102 then refers to the country information DB 400 by using the terminal identification number as a key and thereby acquires country information (location country information; e.g., C1).

The location based authorization determination unit 102 refers to the mobile carrier information DB 104 by using the acquired country information (location country information; e.g., C1) as a key and thereby acquires corresponding one or a plurality of country information (carrier country information; e.g., C2), and then matches this country information (carrier country information; e.g., C2) with the country information (payment country information; e.g., C2) contained in the authorization request.

When the country information matches, the location based authorization determination unit 102 refers to the fraud payment information DB 106 by using a combination of the country information (location country information; e.g., C1) acquired from the country information DB 400 and the country information (payment country information; e.g., C2) in the authorization request as a key, and calculates a fraud rate (0.01% in this example).

Then, the location based authorization determination unit 102 returns this fraud rate to the authorization control unit 101. The authorization control unit 101, 02, transmits the fraud rate to the authorization comprehensive determination unit 107 and makes an inquiry about the legitimacy of this payment.

The authorization comprehensive determination unit 107 determines the legitimacy of the payment on the basis of the fraud rate, and returns a result to the authorization control unit 101. The authorization comprehensive determination unit 107 comprehensively determines the legitimacy of the payment in consideration also of other information, which is not shown.

On the other hand, there is a case where the location based authorization determination unit 102 is unable to derive the fraud rate by referring to the fraud payment information DB 106. For example, there is a case where the combination does not exist in the fraud payment information DB 106. In such a case, the location based authorization determination unit 102 refers to the country location relationship information DB 105 and acquires the adjacent relationship between the countries. When this combination exists, the location based authorization determination unit 102 returns this information as an inquiry result to the authorization control unit 101.

The authorization control unit 101 makes an inquiry about information that this combination exists to the authorization comprehensive determination unit 107, acquires a comprehensive determination result in the authorization comprehensive determination unit 107, and transmits this result to the affiliated store 200. Note that, although the authorization comprehensive determination unit 107 is generally adjusted to determine a payment to be legitimate when the countries are adjacent, it makes a comprehensive determination by taking other information into consideration.

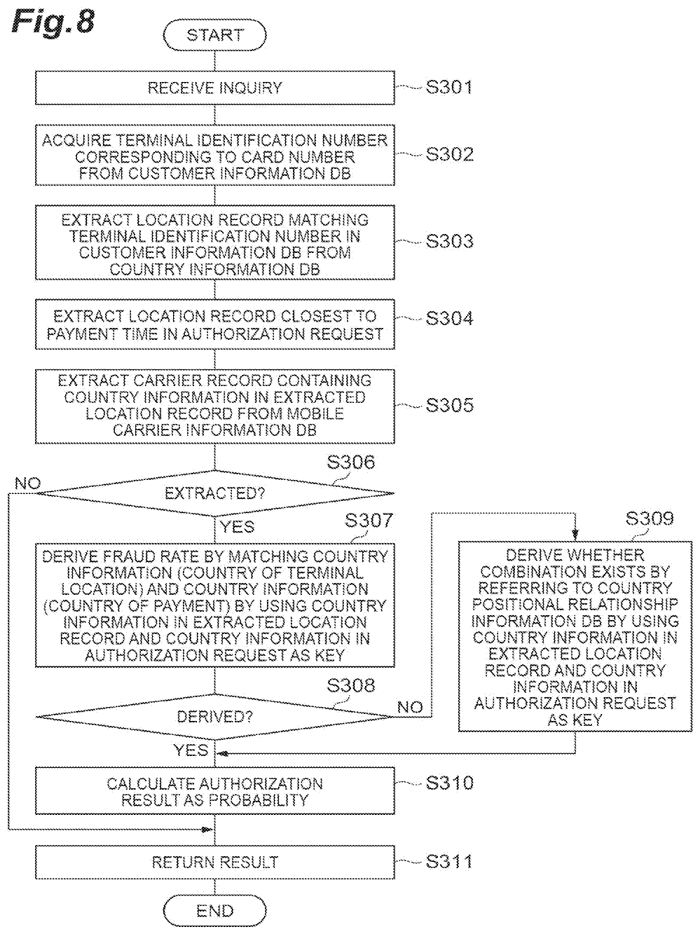

An operation of the authorization server 100c is described hereinafter. FIG. 8 is a flowchart showing the operation thereof. Steps 301 to S304 in FIG. 2 are the same as Steps 201 to S204. Specifically, when the location based authorization determination unit 102 receives an inquiry of an authorization request from the authorization control unit 101, it extracts a location record (location country information) of the communication terminal 300 by referring to the customer information DB 103 and the country information DB 400 (S301 to S304).

The location based authorization determination unit 102 extracts a carrier record containing country information (location country information) of this location record from the mobile carrier information DB 104 (S305).

When the corresponding carrier record is not extracted (No in S306), the location based authorization determination unit 102 generates information indicating this and returns it to the authorization control unit 101 (S311).

When the corresponding carrier record is extracted (Yes in S306), the location based authorization determination unit 102 derives the fraud rate corresponding to the combination of the country information (location country information) in the extracted location record as a country of terminal location and the country information (payment country information) in the authorization request as a country of payment by referring to the fraud payment information DB 106 (S307).

When the fraud rate is derived (Yes in S308), the location based authorization determination unit 102 calculates this fraud rate as the probability of the authorization request (S310), and returns this fraud rate to the authorization control unit 101 (S311).

When the fraud rate is not derived (No in S308), the location based authorization determination unit 102 refers to the country location relationship information DB 105, and determines whether this combination exists in the country information (payment country information) in the authorization request and the country information (location country information) in the extracted location record, that is, whether the countries (the country of location and the country of payment) indicated by the respective country information are adjacent to each other (S309). When it is determined the countries are adjacent, the location based authorization determination unit 102 generates information indicating that the country of location where the communication terminal 300 is located and the country of payment where the payment was made are adjacent to each other, and further calculates this probability and returns it to the authorization control unit 101 (S311). In this step, the probability of legitimate payment may be set to 100% (thus, the fraud rate is 0%) when the countries are adjacent, or a predetermined probability may be derived as the probability of legitimacy or the fraud rate.

As described earlier in the second embodiment, the location based authorization determination unit 102 may calculate the probability of legitimate payment by using the number of candidate countries and invert this probability to calculate the probability of fraud payment in S305, and further multiply this value by the fraud rate to calculate the final fraud rate in S307.

The authorization control unit 101 receives any of information indicating that a record is not extracted from the mobile carrier information DB 104 in Step S306, the fraud rate, and information indicating whether the countries are adjacent or not from the location based authorization determination unit 102, and makes an inquiry to the authorization comprehensive determination unit 107. The authorization comprehensive determination unit 107 determines the legitimacy of this payment on the basis of that information. Although the authorization comprehensive determination unit 107 is adjusted to determine a payment to be a fraud use when information is not extracted in Step S306, it makes a determination by taking other information into consideration. Further, although the authorization comprehensive determination unit 107 is adjusted to determine a payment to be a fraud use also for information indicating that the countries are not adjacent, it makes a determination by taking other information into consideration.

An authorization server 100d according to a fourth embodiment is described hereinafter. The case where country information obtained from base station information is different from the reality is described in the above embodiment. However, the case also exists where country information obtained from an affiliated store is different from the reality. For example, there is a possibility of an extension in global chain stores expanding overseas.

Therefore, a correspondence table between terminal identification numbers and country information is created using the past information, and a match between a country corresponding to a terminal identification number (which corresponds to the terminal identification number of the communication terminal 300) and a country of the user terminal is determined in this correspondence table.

Since country information contained in an authorization request is not used in this way, the above-described problem is solved.

The above-described correspondence table is previously created on the basis of terminal identification numbers and country information of user terminals by using legitimate payment data.

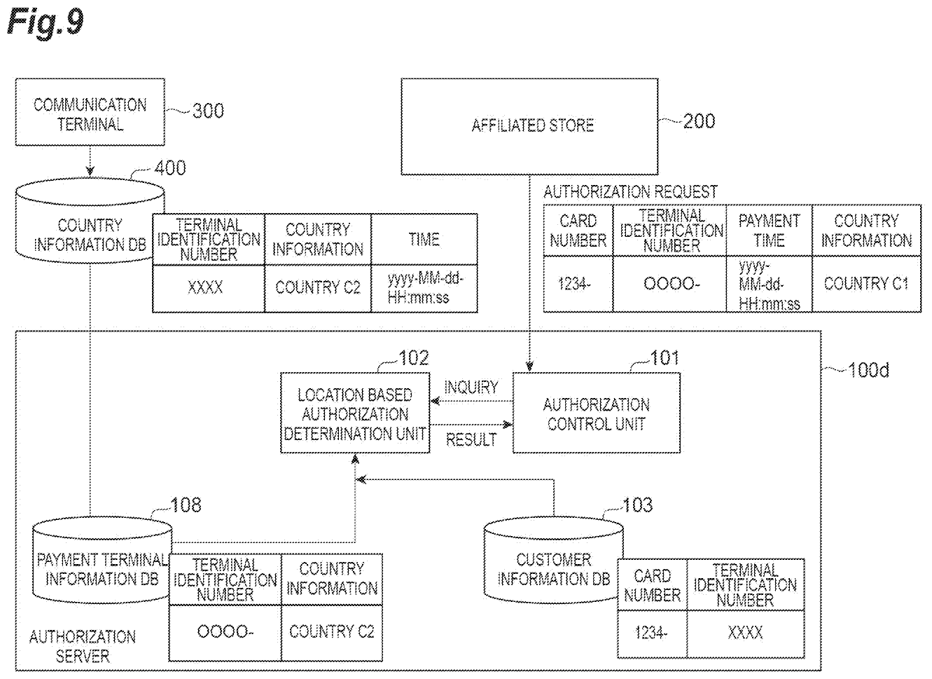

FIG. 9 is a block diagram showing a functional configuration of the authorization server 100d according to the fourth embodiment. As shown therein, the authorization server 100d further includes a payment terminal information DB 108 in addition to the configuration of the authorization server 100 according to the first embodiment. This payment terminal information DB 108 is a database that stores the above-described correspondence table, and it stores terminal identification numbers and country information.

The location based authorization determination unit 102 acquires an authorization request through the authorization control unit 101. This authorization request contains a card number, a payment terminal number, payment time, and country information.

The location based authorization determination unit 102 refers to the payment terminal information DB 108 by using the payment terminal number in the authorization request as a key, and acquires country information corresponding to this payment terminal number. Further, the location based authorization determination unit 102 refers to the country information DB 400, and acquires country information corresponding to the terminal identification number corresponding to the payment terminal number. The location based authorization determination unit 102 determines whether those acquired country information match or not.

The location based authorization determination unit 102 determines that this payment is legitimate when the country information match, and it determines that this payment is not legitimate when the country information do not match.

The authorization control unit 101 transmits this result to the affiliated store 200.

In this manner, it is capable of determining the legitimacy of a payment without need for country information contained in an authorization request. Therefore, even when country information in an authorization request from the affiliated store 200 is different from the reality, the legitimacy of a payment is determined accurately.

The operational advantages of the authorization server 100 according to the first embodiment to the authorization server 100d according to the fourth embodiment are described hereinbelow.

The authorization server 100 according to the first embodiment includes a customer information database that stores a card number of a credit card, which is a payment means, and the communication terminal 300, which is a user terminal, in association with each other. The location based authorization determination unit 102 determines the legitimacy of a payment with the credit card on the basis of whether location country information based on location registration of the communication terminal 300 when the payment with the credit card is made and country information (payment country information in an authorization request) satisfy a predetermined condition or not. The authorization control unit 101 transmits a determination result about the legitimacy of the payment to the affiliated store 200.

The legitimacy of a payment with a credit card is thereby accurately determined on the basis of a country where the communication terminal 300 is located and a payment country where the credit card payment is made.

The authorization server 100 according to the first embodiment is configured to be accessible to the country information DB 400 that stores country information of a country where the communication terminal 300 is located and a time when it is located in this country. The location based authorization determination unit 102 then acquires country information (location country information) from the country information DB 400 on the basis of the time when a payment with a credit card is made and determines the legitimacy of the payment.

The country information where the communication terminal 300 is located is thereby acquired easily by using the country information DB 400 that stores a country of location based on location registration.

The authorization server 100a according to the second embodiment further includes the mobile carrier information DB 104 that stores country information (carrier country information) indicating countries to which a mobile carrier provides communications lines in addition to the functions of the authorization server 100. The location based authorization determination unit 102 acquires, from the mobile carrier information DB 104, country information (carrier country information) of another country covered by a mobile carrier by using the country where the communication terminal 300 is located as a key. The location based authorization determination unit 102 determines the legitimacy of a payment with a credit card by using this country information (carrier country information) and country information (payment country information) in an authorization request. In this second embodiment, when there is only one mobile carrier in this country, the above process is achievable without need to identify the mobile carrier.

The authorization server 100b according to an alternative example of the second embodiment further includes the mobile carrier information DB 104 that stores country information (carrier country information) indicating countries to which a mobile carrier provides communications lines in addition to the functions of the authorization server 100. The location based authorization determination unit 102 identifies the mobile carrier used by the communication terminal 300, and acquires, from the mobile carrier information DB 104, country information (carrier country information) of a country covered by this mobile carrier. The location based authorization determination unit 102 determines the legitimacy of a payment with a credit card by using this country information (carrier country information) and country information (payment country information) in an authorization request.

The legitimacy of a payment is thereby determined by determining a match or mismatch between country information covered by a mobile carrier used by the communication terminal 300 and country information of a country of payment. This enables determination of a country where the communication terminal 300 is located even when country information of country information is information about a mobile carrier.

The authorization server 100c according to the third embodiment further includes the fraud payment information DB 106 that stores a combination of location country information of a country where the communication terminal 300 is located and payment country information of a country where a payment is made, and a fraud rate. The location based authorization determination unit 102 refers to the fraud payment information DB 106 storage unit and acquires a fraud rate corresponding to country information (location country information) acquired from the country information DB 400 and country information (payment country information) in an authorization request. The location based authorization determination unit 102 determines the legitimacy of the payment on the basis of this fraud rate.

The fraud rate based on a country of location where the communication terminal 300 is located and a country of payment where a payment is made is thereby derived, and a determination about the legitimacy of the payment based on this fraud rate is made. This allows a fraud use to be determined accurately when a predetermined fraud rate is obtained between the country of location and the country of payment.

The authorization server 100c further includes the location relationship information DB 105 that stores location relationship information between countries. When the fraud rate is not acquired, the location based authorization determination unit 102 determines the legitimacy of a payment by referring to the location relationship information DB 105.

Thus, even when there is no information about the fraud rate, the legitimacy of a payment is determined on the basis of the location relationship between a country of payment and a country of location.

The authorization server 100c further includes the mobile carrier information DB 104 that stores a plurality of country information indicating countries covered by a mobile carrier. The location based authorization determination unit 102 performs acquisition of the fraud rate when country information based on location registration of the communication terminal 300 and country information based on a location of the affiliated store 200 where a payment is made contained in an authorization request are associated with the mobile carrier information DB 104. When there is no association, the location based authorization determination unit 102 determines the legitimacy of a payment without acquiring the fraud rate.

A country where the communication terminal 300 is located is thereby determined in consideration of an extension of a mobile carrier. Specifically, some mobile carriers are likely to extend lines to an adjacent country by an extension of a communication network. Thus, country information stored in the country information DB 400 and country information where the communication terminal 300 is actually located can be different in some cases. A country where the communication terminal 300 is located is determined in consideration of such an extension, and the legitimacy of a payment is determined using it. This enables a determination about the legitimacy of a payment in consideration of an extension, which achieves an accurate determination.

The authorization server 100d according to the fourth embodiment further includes the customer information DB 10 that stores a card number of a credit card, which is a payment means, and the communication terminal 300, which is a user terminal, in association with each other, and the payment terminal information DB 108 that stores identification information (payment terminal identification number) of the communication terminal 300 used for a payment and country information.

Then, the location based authorization determination unit 102 refers to the payment terminal information DB 108 and acquires country information corresponding to the identification information of the communication terminal 300 used for a credit card payment. The location based authorization determination unit 102 determines the legitimacy of the credit card payment on the basis of the acquired country information and location country information based on location registration of the communication terminal 300 when the credit card payment was made. Then, the authorization control unit 101 outputs a determination result about the legitimacy of the payment.

This configuration allows the legitimacy of a payment with a credit card to be made without using country information contained in an authorization request transmitted from the affiliated store 200.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

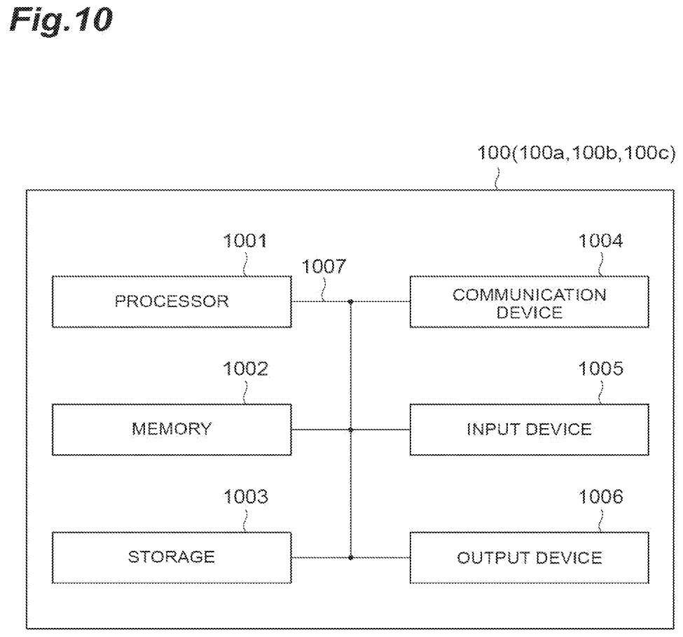

For example, the authorization server 100 or the like according to one embodiment of the present disclosure may function as a computer that performs processing of an authorization method according to the present disclosure. FIG. 10 is a view showing an example of the hardware configuration of the authorization server 100 or the like according to one embodiment of the present disclosure. The authorization server 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the authorization server 100 or the like may be configured to include one or a plurality of the devices shown in the drawings or may be configured without including some of those devices.

The functions of the authorization server 100 or the like may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the authorization server 100, the location based authorization determination unit 102 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the location based authorization determination unit 102 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (Erasable Programmable ROM), EEPROM (Electrically Erasable Programmable ROM), RAM (Random Access Memory) and the like, for example. The memory 1002 may be also called a register, a cache, a main memory (main storage device) or the like. The memory 1002 can store a program (program code), a software module and the like that can be executed for implementing an authorization method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the authorization server 100 or the like may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

Further, each of the aspects/embodiments described in the present disclosure may be applied to at least one of a system using LTE (Long Term Evolution), LTE-A (LTE Advanced), SUPER 3G, IMT-Advanced, 4G (4th generation mobile communication system), 5G (5th generation mobile communication system), FRA (Future Radio Access), NR (new Radio), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra Wide Band), Bluetooth (registered trademark), or another appropriate system and a next generation system extended on the basis of these systems. Further, a plurality of systems may be combined (e.g., a combination of at least one of LTE and LTE-A, and 5G) for application.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middle ware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

The terms “system” and “network” used in the present disclosure are used to be compatible with each other.

Further, information, a parameter and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

Furthermore, “means” in the configuration of each device described above may be replaced by “unit”, “circuit”, “device” or the like.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner

### REFERENCE SIGNS LIST

100 . . . authorization server, 100a . . . authorization server, 100b . . . authorization server, 100c . . . authorization server, 101 . . . authorization control unit, 102 . . . location based authorization determination unit, 103 . . . customer information DB, 104 . . . carrier information DB, 105 . . . country location relationship information DB, 106 . . . fraud payment information DB, 107 . . . authorization comprehensive determination unit, 200 . . . affiliated store, 300 . . . communication terminal, 400 . . . country information DB, 400a . . . country information DB

1. An authorization device comprising:
a customer information storage unit configured to store a payment means and a user terminal in association with each other;
a determination unit configured to determine legitimacy of a payment with the payment means on the basis of whether location country information based on location registration of the user terminal when the payment with the payment means is made and country information based on a location of a store where the payment with the payment means is made satisfies a predetermined condition or not; and
an output unit configured to output a determination result about legitimacy of the payment.

2. The authorization device according to claim 1, wherein
the authorization device is configured to be accessible to a country information storage unit configured to store country information of a country where a user terminal is located and a time when the user terminal is located in the country, and
the determination unit acquires country information from the country information storage unit on the basis of a time when a payment with the payment means is made, and determines legitimacy of the payment.

3. The authorization device according to claim 1, further comprising:
a mobile carrier information storage unit configured to store country information indicating a country covered by a mobile carrier, wherein
the determination unit acquires country information of another country covered by a mobile carrier from the mobile carrier information storage unit on the basis of country information where the user terminal is located, and determines legitimacy of the payment by using the country information.

4. The authorization device according to claim 2, further comprising:
a mobile carrier information storage unit configured to store country information indicating a country covered by a mobile carrier, wherein
when the country information storage unit stores mobile carrier information as country information,
the determination unit identifies a mobile carrier used by the user terminal from the mobile carrier information storage unit, acquires country information of a country covered by the mobile carrier from the mobile carrier information storage unit, and determines legitimacy of the payment by using the country information.

5. The authorization device according to claim 1, further comprising:
a fraud payment information storage unit configured to store a combination of location country information of a country where a user terminal is located and payment country information of a country where a payment is made and a fraud rate, wherein
the determination unit acquires a fraud rate corresponding to country information based on the location registration and country information based on a location of a store where the payment is made by referring to the fraud payment information storage unit, and the determination unit determines legitimacy of the payment on the basis of the fraud rate.

6. The authorization device according to claim 5, further comprising:
a location relationship information storage unit configured to store location relationship information between countries, wherein
when the fraud rate is not acquired, the determination unit determines legitimacy of the payment on the basis of a location relationship of countries respectively indicated by country information based on the location registration and country information based on a location of a store where the payment is made by referring to the location relationship information storage unit.

7. The authorization device according to claim 5, further comprising:
a mobile carrier information storage unit configured to store a plurality of country information indicating countries covered by a mobile carrier, wherein
when country information based on the location registration and country information based on a location of a store where the payment is made are associated with the mobile carrier information storage unit, the determination unit performs acquisition of a fraud rate.

8. The authorization device according to claim 7, wherein when country information based on the location registration and country information based on a location of a store where the payment is made are not associated with the mobile carrier information storage unit, the determination unit determines legitimacy of the payment without performing acquisition of the fraud rate.

9. An authorization device comprising:
a customer information storage unit configured to store a payment means and a user terminal in association with each other;
a payment terminal information storage unit configured to store identification information of a user terminal and country information;
a determination unit configured to acquire country information corresponding to identification information of a user terminal used for a payment with the payment means by referring to the payment terminal information storage unit, and determine legitimacy of the payment with the payment means on the basis of the country information and location country information based on location registration of the user terminal when the payment with the payment means is made; and
an output unit configured to output a determination result about legitimacy of the payment.

10. The authorization device according to claim 2, further comprising:
a mobile carrier information storage unit configured to store country information indicating a country covered by a mobile carrier, wherein
the determination unit acquires country information of another country covered by a mobile carrier from the mobile carrier information storage unit on the basis of country information where the user terminal is located, and determines legitimacy of the payment by using the country information.

11. The authorization device according to claim 2, further comprising:
a fraud payment information storage unit configured to store a combination of location country information of a country where a user terminal is located and payment country information of a country where a payment is made and a fraud rate, wherein
the determination unit acquires a fraud rate corresponding to country information based on the location registration and country information based on a location of a store where the payment is made by referring to the fraud payment information storage unit, and
the determination unit determines legitimacy of the payment on the basis of the fraud rate.

12. The authorization device according to claim 6, further comprising:
a mobile carrier information storage unit configured to store a plurality of country information indicating countries covered by a mobile carrier, wherein
when country information based on the location registration and country information based on a location of a store where the payment is made are associated with the mobile carrier information storage unit, the determination unit performs acquisition of a fraud rate.
